(19) United States
(12) Patent Application Publication
(10) Pub. No.: US 2005/0217419 A1
(43) Pub. Date: Oct. 6, 2005

(54) Automatic gearbox with a transmission housing arranged with the actuator

(76) Inventors: Matthias Winkel, Weingarten (DE); Jerome Lochard, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 11/098,627

(22) Filed: Apr. 4, 2005

(30) Foreign Application Priority Data
Apr. 6, 2004 (DE) 10 2004 016 903.9

(51) Int. Cl. B60K 41/02

(52) U.S. Cl. 74/606 R

(57) ABSTRACT

An automatic transmission with at least one actuator (8) arranged on the transmission housing (4). To reduce repair and/or maintenance costs, the one actuator (8, 8a, 8b, 8c) is arranged on the transmission housing (4) in such a manner that it is freely accessible without removing the automatic transmission (13, 14) from a vehicle.

The invention relates to an automatic transmission with an actuator arranged on the transmission housing in accordance with the preamble of claim 1, and to a motor vehicle according to the preamble of claim 12.

From DE 101 43 325 A1 an automatic transmission is known, in which the actuators for carrying out gearshift-related selection and engagement movements are arranged on the upper side of the transmission housing. Although such an arrangement can be advantageous for the assembly of such a transmission, once it has been fitted into a vehicle, this placement of the actuators is rather obstructive. If such an actuator or an electronic control and regulation element of the transmission spatially associated therewith have to undergo repair or be replaced completely then, in the known automatic transmissions and vehicle drive trains, other vehicle or drive train components, such as the turbocharger, pipes or the vehicle bottom, usually impede the process. For that reason, to carry out such work in the known transmissions, until now, it has been necessary to remove the transmission completely, which is deemed disadvantageous above all from the standpoint of servicing costs.

Against this background, the purpose of the present invention is to propose an automatic transmission in which at least one actuator is easily accessible for maintenance or repair, even without removing the transmission completely from a vehicle.

This objective is achieved as regards the automatic transmission by the characteristics of the principal claim, and as regards the vehicle by those of claim 12. Advantageous further developments and design features of the invention are described in the dependent claims.

The invention is based on the realization that at least one actuator is more easily accessible for servicing if it is not positioned on the top side of the transmission housing and/or if the latter can be tilted and/or rotated while still in the vehicle.

In accordance with this concept, the invention's point of departure is an automatic transmission with at least one actuator on the transmission housing in which, to achieve the stated objective, it is provided that at least one actuator is arranged on the transmission housing in such manner that it is freely accessible, for example, to a vehicle mechanic, without removing the transmission as a whole from the vehicle.

In accordance with a preferred design embodiment of the invention, at least one actuator is arranged on the underside of the transmission housing. In other cases, it may even be sufficient for at least one actuator to be positioned on the side of the transmission housing owing to the space situation in the vehicle.

Technically, more elaborate variants of the invention provide that the transmission housing or a part thereof is mounted on the vehicle in such a manner that it can tilt about a tilt axis and, bearing devices suitable for this are provided both on the automatic transmission and on the associated parts of the vehicle.

If the automatic transmission is made such that it can tilt, it is found particularly advantageous for the tilt axis to be orientated essentially transversely relative to the length of the automatic transmission.

A mounting, which is as a rule more elaborate, is provided on the transmission housing and on the parts of the vehicle if the transmission housing or part thereof are intended to rotate about its longitudinal axis, so that any point on the periphery of the transmission housing can be turned to a position that is convenient for the vehicle mechanic.

To reduce the technical elaboration and cost entailed in providing free accessibility of at least one actuator on the transmission housing, it can be provided that the transmission housing or part thereof is mounted so that it can rotate and/or tilt by at least 90°. In the tilting case, the automatic transmission is moved from an essentially horizontal position in the vehicle to an essentially vertical position which, from the standpoint of a vehicle mechanic under the vehicle, represents the best technical solution. In the case, when the transmission is mounted so that it can only rotate about its longitudinal axis, rotation of the transmission housing or part thereof through 90° fulfills the minimum requirement for free access to an actuator which, in the operating position of the transmission, would be located at the top of the transmission housing. It is still better, however, for rotation through 180° to be made possible.

A structure of the automatic transmission, in accordance with the invention, is particularly advantageous for transmission types in which at least one actuator is arranged on the transmission housing in an area away from the clutch housing thereof.

Since the electronic control and regulation element of the automatic transmission can be arranged close to the at least one actuator when the automatic transmission is constructed, according to the invention, this too can be accessed more conveniently for repair purposes.

It should be mentioned that at least one actuator can be made for hydraulic, pneumatic or electric operation. Usually, more than one such actuator is incorporated in an automatic transmission, for example, an automatic gearbox or a change-under-load twin-clutch transmission, to produce gear selection and gear engagement movements.

Finally, according to the invention, the automatic transmission comprises means on the transmission housing and/or on its clutch housings, whereby it can be mounted to rotate and/or tilt on a vehicle component, in particular, the vehicle body or for servicing purposes whereby it can be mounted to rotate and/or tilt thereon by way of suitable fastenings, such as pivot bolts or pivot bearings.

Lastly, the invention also concerns a motor vehicle constructed such that an automatic transmission, built as described, can be fitted thereto as part of a vehicle drive train, in such a manner that it can rotate and/or tilt. Therefore, the vehicle comprises a body, a drive engine and the automatic transmission on the transmission housing of which is arranged at least one actuator. In addition, it is provided that on the automatic transmission and on a vehicle component, in particular, the vehicle body, tilting and/or rotation means for the automatic transmission are arranged or can be fitted for servicing purposes.

To clarify the invention, the description of a drawing is given below, with reference to which two example embodiments can be explained. The drawing shows:

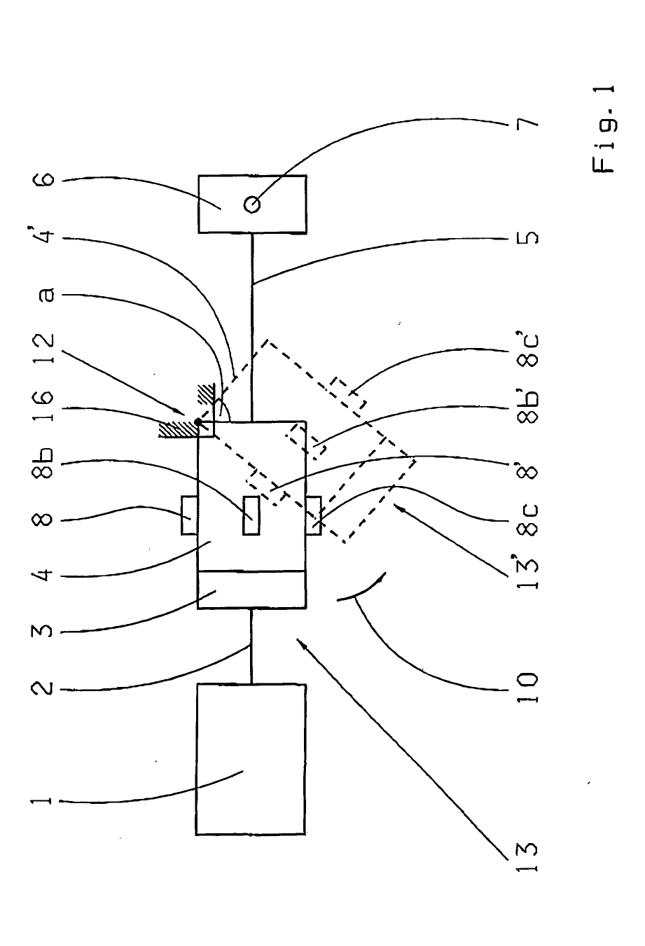

FIG. 1 is a schematic side view of a motor vehicle drive train with an automatic transmission arranged so that it can tilt; and

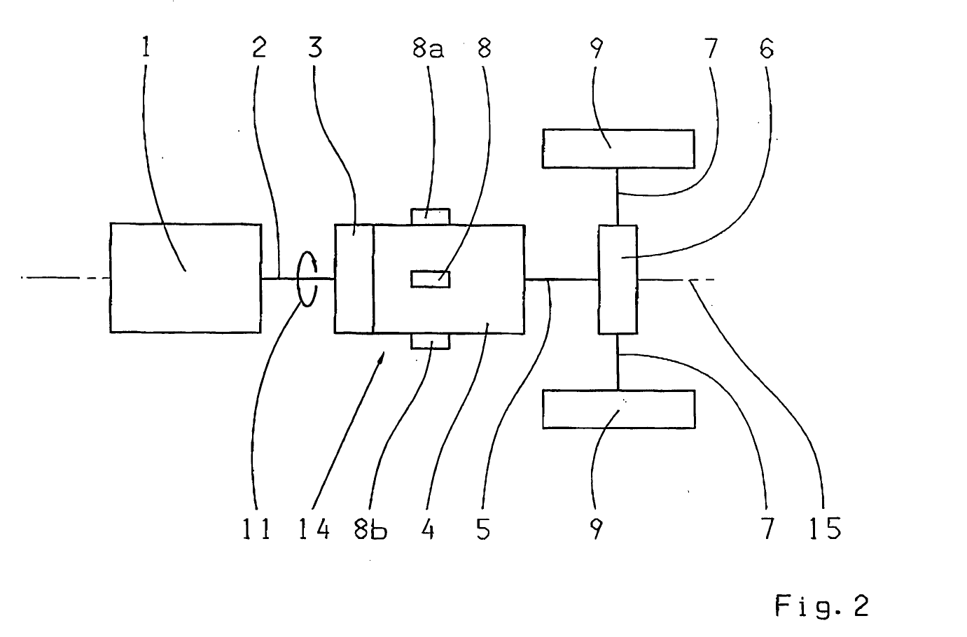

FIG. 2 is a diagrammatic view of a motor vehicle drive train with an automatic transmission that can rotate about its longitudinal axis.

In the drawing, FIG. 1 shows a side view of a motor vehicle drive train in which a drive engine 1 is in driving connection via a drive shaft 2 with an automatic transmission 13 formed as an automatic gearbox. On the drive output side of the automatic gearbox 13 can be seen a drive output shaft 5, by means of which a differential 6 can be driven. As is more clearly apparent in FIG. 2, from this differential 6 two axle drive shafts 7 extend laterally, these transmitting the drive torque to the vehicle wheels 9.

On a transmission housing 4 of the automatic transmission 13 and some distance away from a clutch housing 3 are arranged actuators 8, 8a, 8b and 8c as alternatives or in addition to one another. The electronic control and regulation element of the transmission can be associated directly with or can be close to these actuators 8, 8a, 8b, 8c. According to a first variant of the invention, at least one actuator 8c is arranged on the underside of the transmission housing 4, and for a vehicle mechanic under the drive train, this is, therefore, easily accessible for carrying out maintenance and/or repair work.

According to another variant shown in FIG. 1, at least one actuator 8a, 8b is arranged on the side of the transmission housing 4. Compared with the known

In a third variant of the invention, inasmuch as at least one actuator 8 is positioned on the upper side of the transmission housing 4 as has usually been the case before now, the present invention provides that the automatic transmission 13 is enabled by tilt devices mounted on the transmission housing 4 and on a component of the motor vehicle, in this case the vehicle body 16, to tilt through an angle “a” about a tilt axis 12 which extends essentially horizontally and transversely relative to a longitudinal axis 15 of the automatic transmission.

As shown in FIG. 1 by the representation of an automatic transmission 13′ drawn with broken lines, a transmission housing 4′, together with its actuators 8′, 8a′, 8b′, 8c′, can be tilted about the tilt axis 12 in the direction of a tilt movement arrow 10 through an angle “a” of at least 45° but preferably 90°, out of the drive train and downward. As a result of this, any position at the periphery of the transmission housing 4′ is easily accessible by a vehicle mechanic.

According to another variant of the invention illustrated in FIG. 2, an automatic transmission 14 or its housing 4 can also be constructed for mounting so that it can rotate about its longitudinal axis 15 on at least one vehicle component. As indicated by a rotation direction arrow 11, such rotation of the transmission 14 makes any position on the axial periphery of the transmission housing 4 and, therefore, any of the actuators 8, 8a, 8b, 8c, easily accessible for a vehicle mechanic when, for example, he is on a lifting platform underneath the vehicle.

It is a feature of the invention that the vehicle, too, or part of its body or other suitable vehicle components, have mountings that co-operate with associated mounting components on the transmission housing 4 of the automatic transmission 13, 14 to enable the tilt and/or rotation movement of the automatic transmission.

### REFERENCE NUMERALS

1 Drive engine
2 Drive shaft
3 Clutch housing
4 Transmission housing
4′ Transmission housing, tilted
5 Transmission drive output shaft
6 Differential
7 Axle drive shaft
8 Actuator; electronic and regulation element
8a Actuator; electronic and regulation element
8b Actuator; electronic and regulation element
8b′ Actuator; electronic and regulation element, tilted
8c Actuator; electronic and regulation element
8c′ Actuator; electronic and regulation element, tilted
9 Vehicle wheel
10 Tilt direction
11 Rotation direction
12 Tilt axis
13 Automatic transmission
13′ Automatic transmission, tilted
14 Automatic transmission
15 Longitudinal axis
16 Vehicle body
α Tilt angle

1-12. (canceled)

13. An automatic transmission with at least one actuator arranged on a transmission housing, comprising at least one actuator (8, 8a, 8b, 8c) arranged on the transmission housing (4) in such manner that the at least one actuator (8, 8a, 8b, 8c) is freely accessible without removing the transmission (13, 14) from a vehicle.

14. The automatic transmission according to claim 13, wherein the at least one actuator (8c) is arranged on an underside of the transmission housing (4).

15. The automatic transmission according to claim 13, wherein the at least one actuator (8a, 8b) is arranged on a side of the transmission housing (4).

16. The automatic transmission according to claim 13, wherein the transmission housing (4) is mounted on the vehicle in such manner that the transmission housing (4) can tilt about a tilt axis (12).

17. The automatic transmission according to claim 16, wherein the tilt axis (12) is orientated essentially transversely relative to a length of the automatic transmission (13).

18. The automatic transmission according to claim 13, wherein one of the transmission housing (4) or part thereof is mounted in such manner that the transmission housing (4) or part thereof can rotate about a longitudinal axis (15) of the transmission housing (4).

19. The automatic transmission according to claim 13, wherein one of the transmission housing (13, 14) or part thereof is mounted so that the transmission housing (4) or part thereof can at least one of rotate and tilt through at least 90°.

20. The automatic transmission according to claim 13, wherein the at least one actuator (8, 8a, 8b, 8c) is arranged on the transmission housing (4) on an area of the transmission housing (4) away from the clutch housings.

21. The automatic transmission according to claim 13, wherein an electronic control and regulation element of the automatic transmission (13, 14) is arranged in an area of the at least one actuator (8, 8a, 8b, 8c).

22. The automatic transmission according to claim 13, wherein the at least one actuator (8, 8a, 8b, 8c) is designed to be operated hydraulically, pneumatically or electrically.

23. The automatic transmission according to claim 13, wherein the transmission (13, 14) comprises on one or more of the transmission housing (4) and a clutch housing (3), a means whereby the transmission (13, 14) is mounted to one or more of rotate and tilt on a vehicle component, in particular the vehicle body (16), or whereby the transmission (13, 14) can be mounted to one or more of rotate and tilt thereon for servicing purposes.

24. A motor vehicle with a body (16), a drive engine (1) and an automatic transmission (13, 14), a transmission housing (4) on which is arranged at least one actuator (8), one or more of a tilting and a rotation device are arranged on the automatic transmission (13, 14) and on a vehicle component, in particular the body (16) of the vehicle, or can be attached thereto for servicing purposes.
